(19) United States
(12) Patent Application Publication
(10) Pub. No.: US 2005/0254193 A1
(43) Pub. Date: Nov. 17, 2005

(54) Pulse transformer for transmitting and receiving signal

(75) Inventors: Moon-Young No, Seoul (KR); Chun-Yoon Ro, Gyeonggi-do (KR)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: DUNOTECH PLC, London (GB)

(21) Appl. No.: 10/512,781

(22) PCT Filed: Oct. 7, 2002
(86) PCT No.: PCT/KR02/01869

§ 371 Date: May 18, 2005

(30) Foreign Application Priority Data
Apr. 29, 2002 (KR) 2002/23326

(51) Int. Cl. H02H 1/00

(52) U.S. Cl. 361/113

(57) ABSTRACT

A pulse transformer for transmitting and receiving signal is disclosed. In order to manufacture a second coil into windings containing a condenser component, the pulse transformer for transmitting and receiving signal to the present invention comprises a first condenser electrode, a second condenser electrode, faced to the first condenser electrode; a dielectric or an insulator, positioned between the first and second condenser electrodes and joined to the first and second condenser electrodes; and first and second lead lines, each connected to the first and second condenser electrodes, for performing a function of power lines in order to transmit the signal or being connected to the power lines. According to the present invention, by employing a condenser component as the input and output portions of the transformer, signal attenuation and noise effect of the transmission lines can be deeply reduced by raising the internal impedance, when transmitting and receiving a pulse signal.

### TECHNICAL FIELD

The present invention relates to a pulse transformer for transmitting and receiving signal, in particular to a pulse transformer for transmitting and receiving signal for reducing signal attenuation and noise effects on transmission lines by employing a transformer having a condenser component at signal input/output portions and getting high impedance.

### BACKGROUND ART

Power Line Communications (PLC) technology is for communication by adopting power lines, which provide power, as a medium and carrying voice and data on a signal of hundreds of kHz to tens of MHz. When the PLC technology is applied, home networking, information home appliances, management of power line network, etc., are possible and their related industries are expected to provide new services and activate the potential markets. In particular, high speed access technology applying the PLC and low speed control technology using the home network are noted as the next generation communication technology by domestic and external communication companies or power service companies.

Since the PLC employs the power lines as the medium, it is difficult to be realized in contrast with the data transfer using communication cables or optical fibers. In particular, the PLC needs to overcome unique circumstance such as heavy loads, interference, noise, variable impedance and signal attenuation, etc., and transfer the data through the limited power lines. If the power lines are adopted as a communication medium, technology for removing various kinds of noise should be provided.

For this, a transformer for transmitting and receiving signal is employed as an intermediate transfer means in the process of data transmission and reception for short and long distances. However, typical structure of the transformer has a limit for long distance transmission when the data transfer is performed in tens of MHz or hundreds of MHz unit. Namely, since the internal impedance is realized and limited by the numbers of first and second coil winding times in the conventional pulse transformer, the above described technical difficulties are generated in the data transfer for hundreds of meters.

### DISCLOSURE OF INVENTION

It is, therefore, an object of the present invention to provide a pulse transformer for transmitting and receiving signal for reducing signal attenuation and noise effects on transmission lines by employing the transformer having a condenser component to signal input/output portions to minimize the number of coil winding times and get high impedance, when impedance matching in an electronic circuit or an insulating structure in a part of the circuit as well as long distance transmission and reception of an electric signal are needed.

To achieve the above object, according to the present invention, there is provided a pulse transformer for transmitting and receiving signal comprises a coil for being input power; and first and second condenser electrodes for being positioned apart from the coil and induced electromagnetically, being one-bodied but electrically separated from each other by a dielectric or an insulator, performing a function of power lines in order to transmit a signal or being formed each lead line connected to the power lines. Preferably, the first and second condenser electrodes are wound in a coil shape.

To achieve the above object, according to the other aspect of the present invention, there is provided a pulse transformer for transmitting and receiving signal comprising a first coil at a first coil side, and a second coil at a second coil side for being induced electromagentically by the first coil, in order to manufacture the second coil into windings containing a condenser component, the second coil comprising a first condenser electrode; a second condenser electrode, faced to the first condenser electrode; a dielectric or an insulator, positioned between the first and second condenser electrodes and joined to the first and second condenser electrodes; and first and second lead lines, each connected to the first and second condenser electrodes, for performing a function of power lines in order to transmit the signal or being connected to the power lines.

At this time, the first and second condenser electrodes are in a line form or in a plate form.

Here, the dielectric or the insulator is comprised selectively on an exposure side of the first condenser electrode or the second condenser electrode in order to prevent the first and second condenser electrodes from being short when the first and second condenser electrodes are wound in a coil shape.

### BRIEF DESCRIPTION OF DRAWINGS

The above objects, features and advantages of the present invention will become more apparent from the following detailed description when taken in conjunction with the accompanying drawings, in which:

FIG. 1 is a schematic diagram illustrating that a pulse transformer for transmitting and receiving signal is comprised at transmission and reception sides on the power lines.

FIG. 2 is an equivalent circuit diagram of the pulse transformer for transmitting and receiving signal at the transmission side.

FIG. 3 is an equivalent circuit diagram of the pulse transformer for transmitting and receiving signal at the reception side.

FIG. 4 is an equivalent serial consonant circuit diagram of A.

FIG. 5 shows a configuration of the pulse transformer for transmitting and receiving signal according to a first embodiment of the present invention.

FIG. 6 shows a configuration of the pulse transformer for transmitting and receiving signal according to a second embodiment of the present invention.

FIG. 7 shows a structure of B in the second embodiment.

FIG. 8 shows the other structure of B in the second embodiment.

FIG. 9 is a schematic diagram illustrating an applied example of the pulse transformer for transmitting and receiving signal of the present invention.

### BEST MODE FOR CARRYING OUT THE INVENTION

A preferred embodiment of the present invention will now be described with reference to the accompanying drawings.

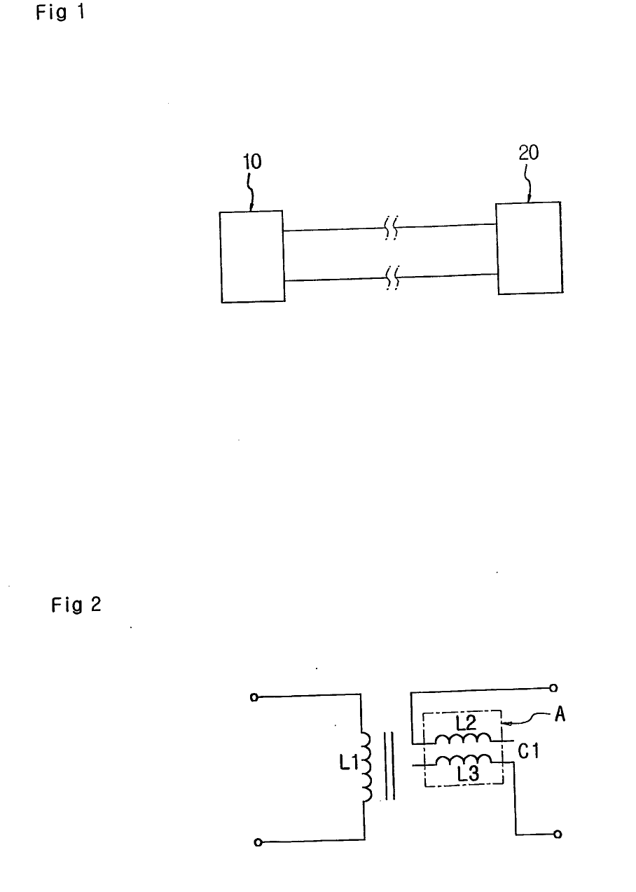

FIG. 1 is a schematic diagram illustrating that a pulse transformer for transmitting and receiving signal is comprised at transmission and reception sides on the power lines. Referring FIG. 1, a pulse transformer 10 for transmitting and receiving signal is positioned at a transmission side in a predetermined region and a pulse transformer 20 for transmitting and receiving signal is positioned at a reception side in the other predetermined region. A typical alternating voltage of 220V, 60 Hz is used between them. To be sure, a voltage provided to general houses and plants from a transformer substation can be more than that.

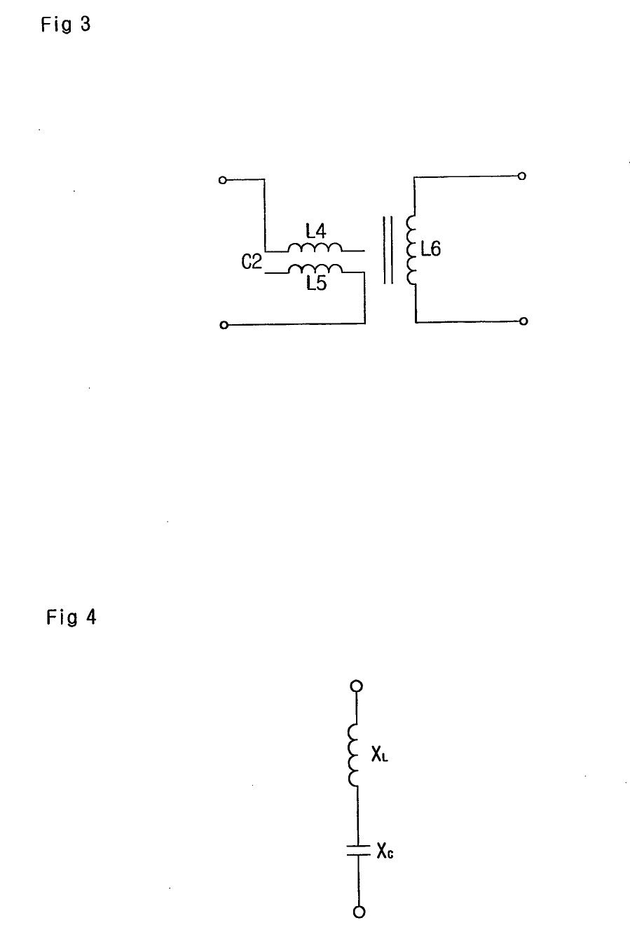

FIG. 2 is an equivalent circuit diagram of the pulse transformer for transmitting and receiving signal at the transmission side. Referring FIG. 2, the pulse transformer for transmitting and receiving signal at the transmission side comprises a first coil L1 at a first coil side, a second coil L2 and a third coil L3 at a second coil side. The second coil L2 and third coil L3 at the second coil side are closely separated and coupled to be a capacitor C1. FIG. 3 is an equivalent circuit diagram of the pulse transformer for transmitting and receiving signal at the reception side. Referring FIG. 3, the pulse transformer for transmitting signal and receiving signal at the reception side comprises a sixth coil L6 at the first coil side, a fourth coil L4 and a fifth coil L5 at the second coil side. The fourth coil L4 and the fifth coil L5 at the second coil side are closely separated and coupled to be a capacitor C2.

FIG. 4 is an equivalent serial consonant circuit diagram of A. Referring FIG. 4, a Q value at the output end, namely a voltage gain, can be obtained by inducing a mixed serial resonance value, X_{L}+X_{C}, from a voltage induced from the condenser itself in a predetermined frequency by making the condenser formed in the second coil side.

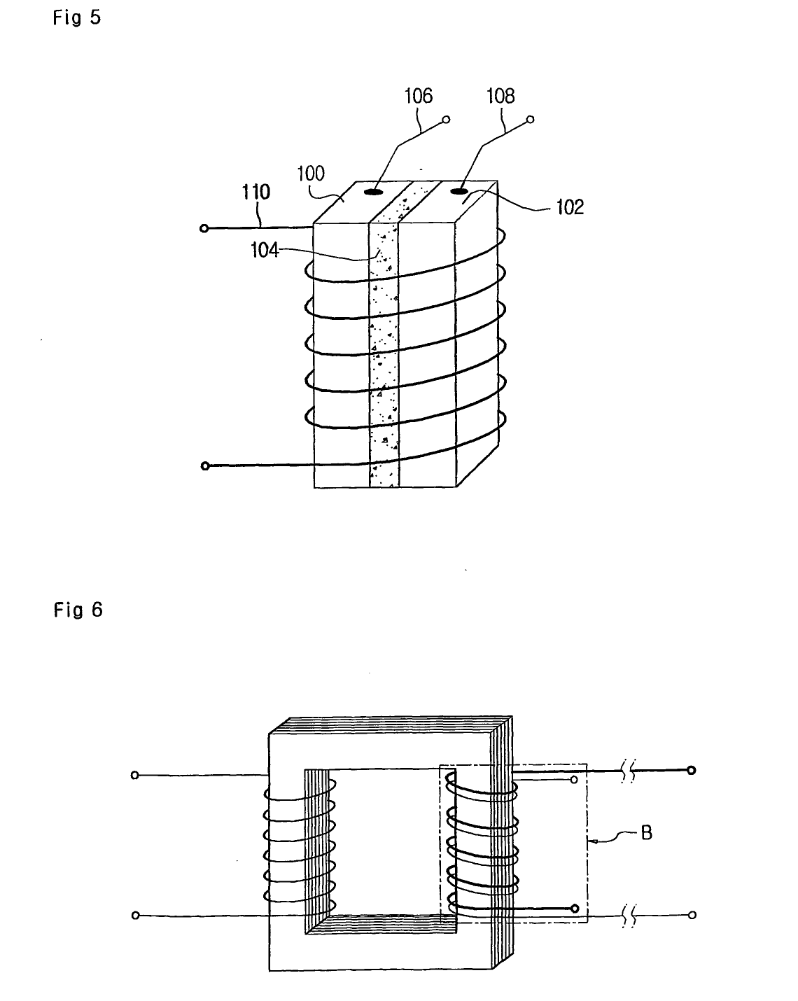

FIG. 5 shows a configuration of the pulse transformer for transmitting and receiving signal according to a first embodiment of the present invention. Referring FIG. 5, a dielectric 104 is formed between a first condenser electrode 100 and a second condenser electrode. A first lead line 106 and a second lead line 108 are formed at the first and second condenser electrodes 100, 102, respectively. A copper line 110 is wound around the first and second condenser electrodes 100, 102 in a predetermined interval like a coil. Consequently, the coil, which winds the transformer once and is formed of the copper line, performs behaviors corresponding to the first and second coil sides of the transformer.

The behaviors according to the present invention are described with accompanying drawings of FIG. 1 to FIG. 5.

When an analog signal is transmitted between the pulse transformers 10, 20 for transmitting and receiving signal at the transmission and reception sides in FIG. 1, a voltage becomes induced to the second coil side C1 in proportion to the number of winding times in case that a signal voltage is applied to the first coil L1 of FIG. 2. At this time, according to a structure of FIG. 5, since both electrode ends show totally 1 winding effect, a voltage corresponding to the 1 winding becomes induced. Capacity of the condenser is as small as 100 pF and internal impedance is as much as several MΩ. A signal received in the pulse transformer 20 for transmitting and receiving signal at the reception side of FIG. 1 induces a voltage in the sixth coil L6 of FIG. 3 as an induced voltage.

As shown in FIG. 1, two lines between the pulse transformers 10, 20 for transmitting and receiving signal at the transmission and reception sides are the power lines using typical alternating power 220V. Accordingly, when a high frequency signal is transmitted and received between the pulse transformers 10, 20 for transmitting and receiving signal at the transmission and reception sides, C1 and C2, the condensers of the pulse transformers 10, 20 of transmitting and receiving signal at the transmission and reception sides, respectively, obtain durability of the pulse transformers basically as much as internal pressure and capacity of an insulator. The voltage generated directly inside the condenser is proportion to an impedance of the following equation.

$${X}_{C} = \frac{1}{2 π fC} \qquad ( 1 )$$

According to the above equation, the impedance is output easier as the frequency goes higher. Consequently, the larger impedance is output for the alternating voltage of 220V, 60 Hz. Actually, when the high frequency is carried on the alternating voltage of 220V, the large impedance is required like the following equation for a parallel configuration in 220V, 60 Hz.
X_{L}=2πfL (2)

If reactance is relatively high, a function of the high frequency signal becomes very small and then the function as a pulse transformer for inputting and outputting a signal becomes lost. If the pulse transformer of the present invention is employed, the internal impedance between the pulse transformers 10,20 for transmitting and receiving signal at the transmission and reception sides becomes several MΩs. Consequently, the following typical side effects can be improved.

That is, signal attenuation can be minimized. When the internal impedance of a first portion, the pulse transformer 10 for transmitting and receiving signal at the transmission side, gets higher, the signal transmission gets easier for long distance. Also, the voltage can be transmitted to the pulse transformer 20 for transmitting and receiving signal at the reception side of FIG. 1, namely C2 of FIG. 3, with noise being relatively lowered along the long distance. This is the most important point of the power line communications. Namely, this can have the strong signal maintained without attenuation by maintaining relatively long transmission distance, not affected by noise accompanied with the AC lines.

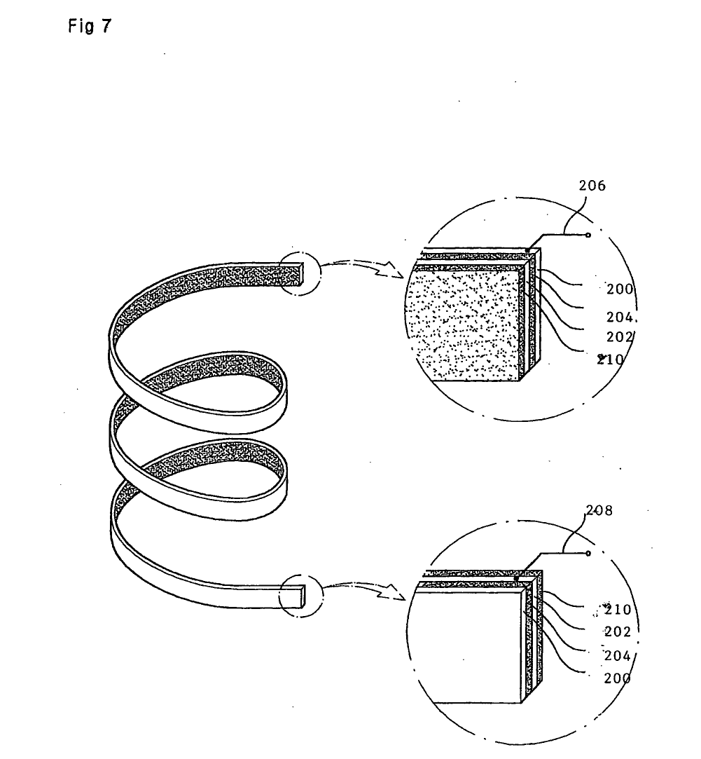

FIG. 6 shows a configuration of the pulse transformer for transmitting and receiving signal according to a second embodiment of the present invention. Referring FIG. 6, the pulse transformer for transmitting and receiving signal comprises a first coil of the first coil side, a second coil and a third coil of a second coil side, formed around a bedded iron core. The present second embodiment is to apply the first and second condenser electrodes of FIG. 5 to a typical configuration of the transformer, and to apply them as a coil type to the second transformer in comparison with the one of FIG. 5. The coupled materials of the first and second condenser electrodes are wound in appropriate frequencies each according to various uses. They also have forms of pair or a plurality of inputs and outputs.

FIG. 7 shows a structure of B in the second embodiment Referring FIG. 7, the structure of B, being able to be applied to the second coil side of FIG. 6, has long plate type metals, first and second metal plates 200, 202, faced each other, a dielectric 204 or an insulator 204 inserted as the same form as the two metal plates 200, 202 between them, first and second lead lines 206, 208 connected to the two metal plates 200, 202, respectively. Then, the same shape as the coil wound around the bedded iron core in FIG. 6 is formed. When winding it in a coil type, the dielectric 210 or insulator 210 can be additionally joined to one exposed side of the two metal plates 200, 202, because the two metal plates 200, 202 can be short according to the winding method.

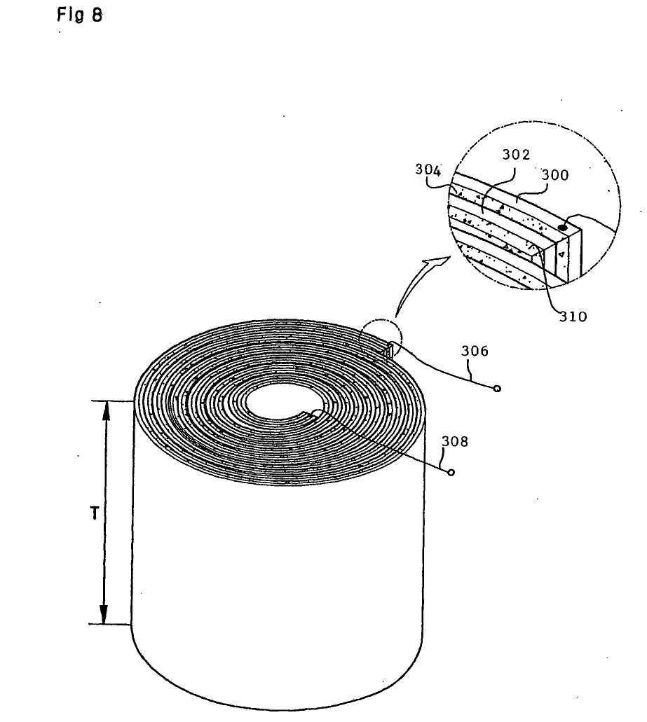

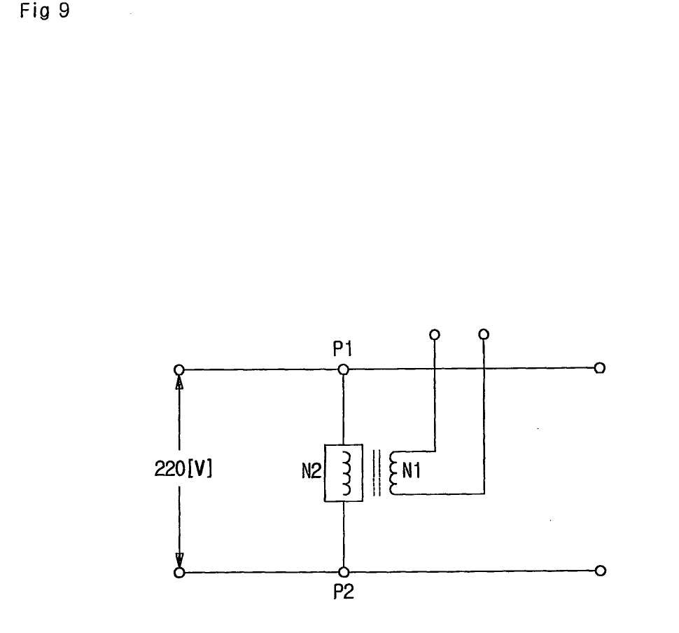

FIG. 8 shows the other structure of B in the second embodiment. Referring FIG. 8, a first metal plate 300, a second metal plate 302, a dielectric 304 or an insulator 304, a first lead line 306 and a second lead line 308 are formed similarly or the same as each one of FIG. 7. The only difference is that the second embodiment has larger area per unit length in comparison with that of FIG. 7. Namely, it has length T, long enough to wind the bedded iron core. As shown in FIG. 7, the dielectric 310 or insulator 210 can be additionally joined to one exposed side of the two metal plates 300, 302, because the two metal plates 300, 302 can be short according to the winding method.

The behaviors according to the embodiments are described with accompanying drawings of FIG. 6 to FIG. 8.

The embodiments have structures for raising the internal impedance of the second coil side of the pulse transformer for transmitting and receiving signal absolutely, without regarding the number of winding times of the first and second coils. For example, in case of high frequency of tens of MHz, an induced reactance value of 6.2 kl can be obtained when 40 times of coil winding around a perforated bobbin with 10 mm diameters results in 100 mH inductance value.

On the contrary, when manufacturing a transformer having the configuration as shown in FIG. 7 or 8 according to the present invention, the transformer can obtain relatively higher impedance under the same conditions. That is, as shown in FIGS. 7 and 8, when forming a condenser consisted with dielectrics or insulators between two plane conductive films, winding the second coil around the condenser like the coil which winds 40 times around the perforated bobbin with 10 mm diameters, and then installing electrodes at both ends of the conductive films, a voltage, proportional to the number of winding times, is charged to and discharged from the condenser repeatedly. Simultaneously, the induced reactance corresponding to the number of winding times of the coil becomes realized in a single object like a composite circuit having X_{L}+X_{C}. At this time, due to a characteristic of discharge of the condenser even to an infinite external resistor, the second coil side output structure having the internal impedance of several or more MΩ becomes realized. Their equivalent values N₂ and C₁ to the ones of FIG. 4 are decided by the following equation.

$$τ r = \frac{1}{2 π \times LC} \qquad ( 3 )$$

As the equation of (3), a serial resonant frequency according to a predetermined frequency is calculated and consequently a voltage gain is amplified like the following equation.

$$Q = \frac{VL}{V} = \frac{VC}{V} = \frac{Wr}{R} = \frac{1}{WrcR} = \frac{1}{R} \times \frac{L}{c} \qquad ( 4 )$$

Since a signal of the second coil side can be larger than the one of the first coil side and the value of being proportional to the number of winding times, it can be implemented as an amplifier for the predetermined frequency.

FIG. 9 is a schematic diagram illustrating an applied example of the pulse transformer for transmitting and receiving signal of the present invention. Referring FIG. 9, the pulse transformer is formed by winding the first coil of the first coil side N1 around the perforated bobbin 40 times, winding the one-bodied second and third coils of the second coil side N2 around the perforated bobbin 40 times too, allowing the internal electricity to tolerate the internal pressure at the alternating voltage of 1000V and then forming a condenser of 100 pF. If several MHz frequency is applied to the first coil side N1 on the power lines of the alternating voltage of 220V, 60 Hz, any other high frequency signal tolerating the alternating voltage can be applied to the alternating power lines as applications because the internal pressure of the insulator of the second coil side N2 connected to P1 and P2 is sufficient to.

While the invention has been shown and described with reference to certain preferred embodiments thereof, it will be understood by those skilled in the art that various changes in form and details may be made therein without departing from the spirit and scope of the invention as defined by the appended claims.

As described above, the pulse transformer for transmitting and receiving signal according to the present invention employs a condenser component as the input and output portions of the transformer so that signal attenuation and noise effect of the transmission lines can be deeply reduced by raising the internal impedance, when transmitting and receiving a pulse signal. In addition, it can be ensured high reliability to a signal, being smaller than 1V, as well as be extremely easily installed in the power lines by processing the second side coil as a condenser with a function of tolerating high voltage.

1. A pulse transformer for transmitting and receiving signal comprising:
a coil for being input power; and
first and second condenser electrodes for being positioned apart from the coil and induced electromagnetically, being one-bodied but electrically separated from each other by a dielectric or an insulator, performing a function of power lines in order to transmit a signal or being formed each lead line connected to the power lines.

2. The pulse transformer according to claim 1, wherein the first and second condenser electrodes are wound in a coil shape.

3. A pulse transformer for transmitting and receiving signal comprising a first coil at a first coil side, and a second coil at a second coil side for being induced electromagnetically by the first coil, in order to manufacture the second coil into windings containing a condenser component, the second coil comprising:
a first condenser electrode;
a second condenser electrode, faced to the first condenser electrode;
a dielectric or an insulator, positioned between the first and second condenser electrodes and joined to the first and second condenser electrodes; and
first and second lead lines, each connected to the first and second condenser electrodes, for performing a function of power lines in order to transmit the signal or being connected to the power lines.

4. The pulse transformer according to claim 1, wherein the first and second condenser electrodes are in a line form.

5. The pulse transformer according to claim 1, wherein the first and second condenser electrodes are in a plate form.

6. The pulse transformer for transmitting and receiving signal according to claim 2, wherein the dielectric or the insulator is comprised selectively on an exposure side of the first condenser electrode or the second condenser electrode in order to prevent the first and second condenser electrodes from being short, when the first and second condenser electrodes are wound in a coil shape.

7. The pulse transformer according to claim 3, wherein the first and second condenser electrodes are in a line form.

8. The pulse transformer according to claim 3, wherein the first and second condenser electrodes are in a plate form.

9. The pulse transformer for transmitting and receiving signal according to claim 3, wherein the dielectric or the insulator is comprised selectively on an exposure side of the first condenser electrode or the second condenser electrode in order to prevent the first and second condenser electrodes from being short, when the first and second condenser electrodes are wound in a coil shape.
